(19) United States
(12) Patent Application Publication
(10) Pub. No.: US 2022/0159929 A1
(43) Pub. Date: May 26, 2022

(54) PET POTTY TRAINING SYSTEMS

(71) Applicants: Anna Hung, Dallas, TX (US); Hsinyi Kao, Dallas, TX (US)

(72) Inventors: Anna Hung, Dallas, TX (US); Hsinyi Kao, Dallas, TX (US)

(21) Appl. No.: 17/670,483

(22) Filed: Feb. 13, 2022

(51) Int. Cl. A01K 15/02; A01K 27/00; A01K 29/00; A01K 23/00

(52) U.S. Cl. CPC A01K 15/021; A01K 23/00; A01K 29/005; A01K 27/009

(57) ABSTRACT

A pet potty training system includes a collar alarm system and a potty training suit. The potty training suit includes a wet sensor attached to an inner surface of the potty training suit and connected to the collar alarm system via a wire. The collar alarm system is attached to the neck of the pet during potty training and beeps or vibrates when receiving a wet signal from the wet sensor. The potty training suit includes a fastening member for securing the wet sensor and the wire on the inner surface of the potty training suit. When a doggy diaper is used, the doggy diaper is attached to the potty training suit by the fastening member.

### FIELD

The present disclosure relates generally to pet potty training systems.

### BACKGROUND

The statements in this section merely provide background information related to the present disclosure and may not constitute prior art.

Water sensor alarm systems have been used on little children to prevent little children from bed-wetting. These wet sensor alarm systems are meant to be used while children are sleeping and cannot be used on pets, particularly dogs. Dogs are active during the day and have a propensity to shake and bite. If used on dogs, the conventional wet sensor alarm systems would easily become loose and would be bitten off by the dogs. When dogs bite off some parts of the conventional wet sensor alarm systems, the wet sensors and the wires connected to the wet sensors may become hanging loose, causing a tripping or choking hazard.

The above issues, among other issues, are addressed by the present disclosure.

### SUMMARY

In one form, a pet potty training system is provided, which includes a potty training suit, and a collar alarm system connected to the potty training suit by a wire. A wet sensor and its associated wire for transmission of a wet signal are attached to the potty training suit. The wet sensor and the wire, as part of the potty training suit, are removably attached to an inner surface of the potty training suit, so that the dog will not be able to get it off. In one variation, the potty training suit is designed to receive and firmly secure any form of doggy diaper on the inner surface of the potty training suit.

In other features, the collar alarm system has different settings for alarm. The collar alarm system can be switched to beep, vibrate, or both, via buttons on the collar. The intensity of the beeps/vibrations can also be adjusted. This way, the alarm can be properly picked and adjusted to suit for the size or weight of the dog. The collar alarm system receives wet signal via the wire from the wet sensor disposed on the inner surface of the potty training suit and generates a beep sound or vibration according to the alarm setting and in response to the wet signal. The collar alarm system, like a regular pet collar, can be securely put on the neck of the dog during the potty training so that the dog cannot shake it off. The collar is adjustable to fit dogs of a variety of sizes. The collar alarm system can be wirelessly controlled using WIFI, Bluetooth, and infrared etc., and can be controlled via a phone app, making it simple and accessible to control the pet potty training system. This allows the system to be quickly turned off if the dog goes outside, showing the dog that it's okay to urinate outside.

In other features, there are different sizes of the potty training suits, as to be used on dogs or pets of different sizes. The collar size can also be adjustable to fit different size dog or pet necks.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a schematic view of a pet potty training system worn by a dog and constructed in accordance with the teachings of the present disclosure;

FIG. 2 is a schematic view of a potty training suit of the pet potty training system of FIG. 1;

FIG. 3 is a schematic view of a collar alarm system of the pet potty training system of FIG. 1; and

FIG. 4 is a partial view of the pet potty training system of FIG. 1 showing the connection between the potty training suit and the collar alarm system.

Corresponding reference numerals indicate corresponding parts throughout the several views of the drawings.

### DETAILED DESCRIPTION

The following description is merely exemplary in nature and is not intended to limit the present disclosure, application, or uses.

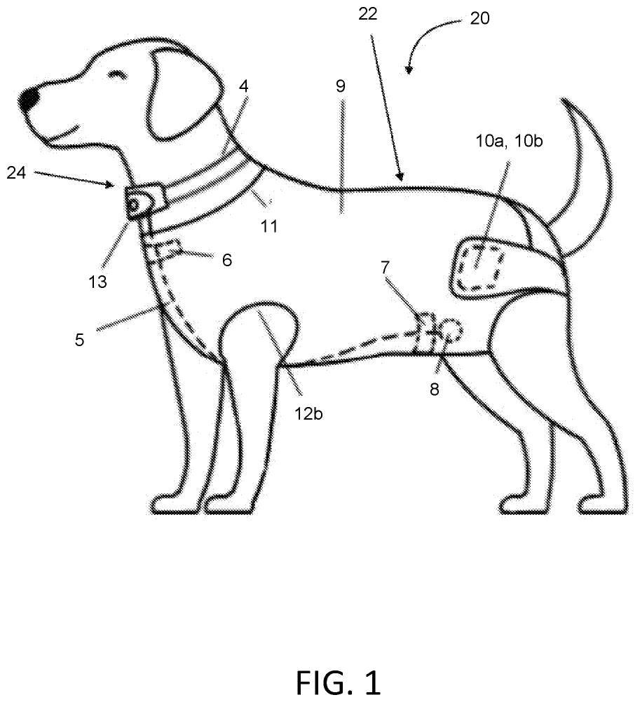

Referring to FIG. 1, a pet potty training system 20 constructed in accordance with the teachings of the present disclosure includes a potty training suit 22 to be worn by a pet, such as a dog or a cat, and a collar alarm system 24. The potty training suit 22 includes a wet sensor 8 for detecting presence of urine from the pet and a wire 5 for connecting the wet sensor 8 to the collar alarm system 24. When the wet sensor 8 detects urine from the pet, the wet sensor 8 generates a signal and transmits the signal via the wire 5 to the collar alarm system 24, which in turn, provides an alert indicating that urine is detected.

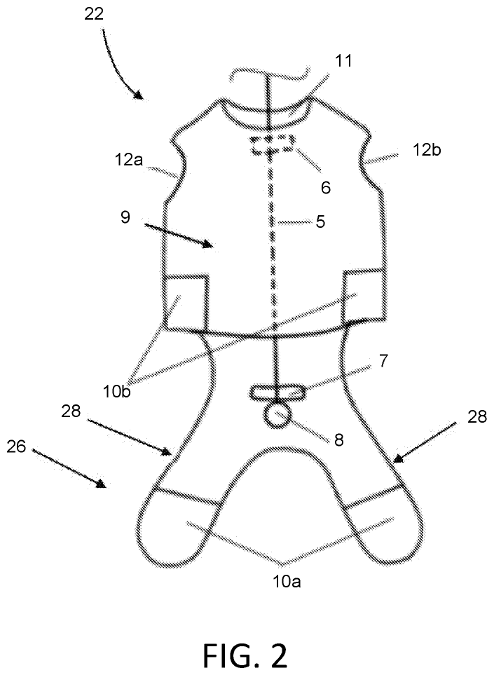

Referring to FIG. 2, the potty training suit 22 is configured to be worn by a pet and includes a front portion 9 and a rear portion 26 connected to a rear end of the front portion 9. The front portion 9 has a vest-like configuration and includes a first opening 11 for the pet's head to come out, and a second opening 12a and a third openings 12b for the pet's front legs to come out. The rear portion 26 has a generally Y-configuration and extends from the rear end of the front portion 9. The rear portion 26 includes two elongated strips or extensions 28 to be wrapped around the rear legs of the pet. The potty training suit 22 further includes a fastening member for fastening the wet sensor 8 and the wire 5 on the inner surface of the potty training suit 22 and for attaching the rear portion 26 of the potty training suit 22 around the rear legs of the pet.

The fastening member may include Velcro® pieces 6, 7, 10a, 10b. The Velcro® pieces 10a, 10b are provided at free ends of the extensions 26 of the rear portion 28 and at the rear end of the front portion 9. When the Velcro pieces 10a, 10b are attached, the extensions 28 of the rear portion 26 can be wrapped around the pet's rear legs and connected to the rear end of the front portion 9 of the potty training suit 22. The Velcro® pieces 6 and 7 may be disposed near the first opening 11 and/or at the rear portion 28 of the potty training suit 22 near the wet sensor 8 for securing the wet sensor 8 and the wire 5 on the inner surface of the potty training suit 22. The potty training suit 22 is designed to receive any form of doggy diapers such that a doggy diaper can be properly positioned between the dog and the potty training suit 22 without being ripped off by the dog. In addition to fastening the wire 5 in place, the Velcro® piece 7 near the wet sensor 8 can also be used to secure a doggy diaper to the potty training suit 22 and prevents the doggy diaper from being bitten or rubbed off.

Instead of using Velcro® pieces 6, 7, 10a, 10b, any conventional fastening means, such as zips, strings, buttons etc., may be used to fasten the extensions 28 to the front portion 9 of the potty training suit 22 and to secure the wire 5 and wet sensor 8 in place without departing from the scope of the present disclosure.

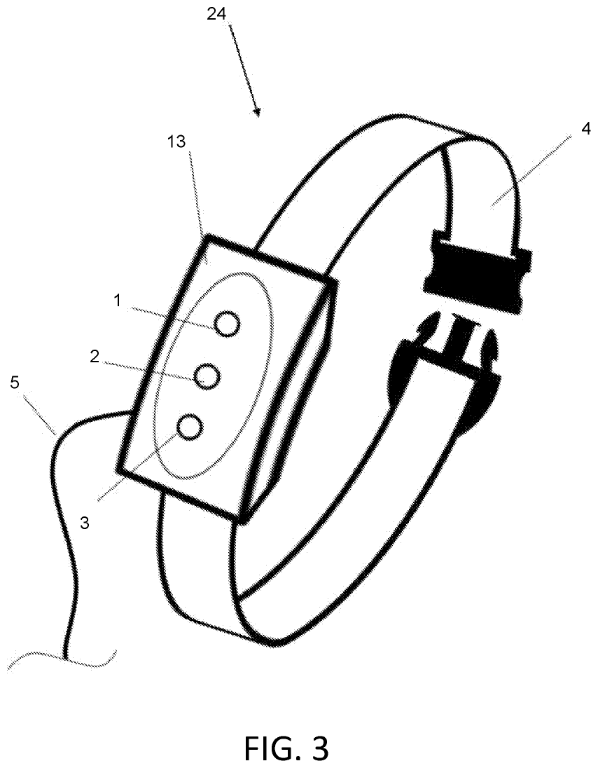

Referring to FIG. 3, the collar alarm device 24 includes a control device 13 and a mounting member 4 for mounting the control device 13 to the pet, particularly the neck of the pet. The control device 13 includes a switch 1 for powering it on/off, a mode selection device 2 and an adjusting device 3. The mode section device 2 allows a user to select from a plurality of modes, such as a beep mode or a vibration mode. The adjusting device 3 allows a user to select the intensity of the beep/vibration, from low, medium to high. In the exemplary embodiment, the switch 1, the mode section device 2 and the adjusting device 3 are in the form of buttons. The control device 13 may be operated manually or wirelessly such as by using WIFI, Bluetooth, and infrared, and can be controlled via a phone app, making it simple and accessible to control the pet potty training system 20.

The control device 13 further contains a mini speaker (not shown) and a vibrator (not shown) to perform beep and vibration functions as needed. The control device 24 generates a beep sound or a vibration near the pet's head when urine is detected by the wet sensor 8. The mounting member 4 may be in the form of a belt or a collar and may be adjustable to fit different pet neck sizes.

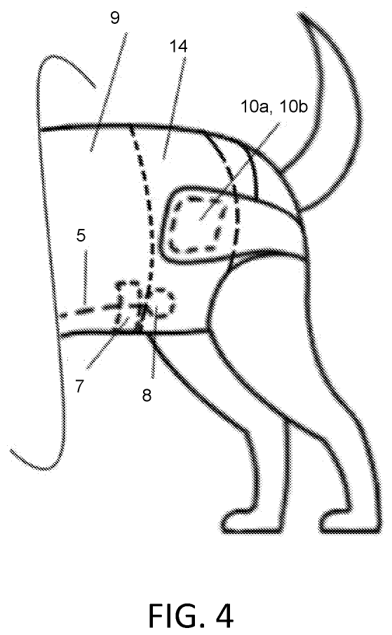

Referring to FIG. 4, when the pet potty training system 20 is worn by a pet, the wire 5 is attached to the inner, belly-side of the front portion 9 of the potty training suit 22. The Velcro® 7 secures the wire 5 in place near the wet sensor 8. Alternatively, if the pet potty training system 20 is used with a diaper 14, the diaper 14 may be placed just under Velcro® piece 7, so the Velcro® piece 7 is not inside the diaper 14, but the wet sensor 8 is placed between the diaper 14 and the dog.

The pet potty training system 20 of the present disclosure has the advantage of being able to potty-train a dog using one integrated product without the fear of becoming loose or being ripped off by the pet during wearing. In addition, the pet potty training system 20 can be used by any other similarly sized pet and can be used with any commercially available doggy diapers.

It should be noted that the disclosure is not limited to the form described and illustrated as examples. A large variety of modifications have been described and more are part of the knowledge of the person skilled in the art. These and further modifications as well as any replacement by technical equivalents may be added to the description and figures, without leaving the scope of the protection of the disclosure and of the present patent.

What is claimed is:

1. A potty training system comprising:
a potty training suit configured to be worn by a pet and including a wet sensor, a wire connected to the wet sensor, and a fastening member for fastening the wet sensor and the wire to an inner surface of the potty training suit; and
a collar alarm system including a control device and a mounting member for mounting the collar alarm system around a neck of the pet, the wire connecting the wet sensor to the control device,
wherein the wet sensor generates a signal when urine from the pet is detected, and transmits the signal to the collar alarm system via the wire, the collar alarm system providing an alert indicating the detection of the urine.

2. The potty training system according to claim 1, wherein the alert is a beep sound or a vibration.

3. The potty training system according to claim 1, wherein the fastening member includes a plurality of Velcro® pieces.

4. The potty training system according to claim 1, wherein the fastening member of the potty training suit is configured to fasten a doggy diaper on the inner surface of the potty training suit.

5. The potty training system according to claim 1, wherein the collar alarm system includes a switch, a mode selection device and an adjusting device.

6. The potty training system according to claim 5, wherein the mode selection device provides a plurality of modes including a beep mode and a vibration mode.

7. The potty training system according to claim 5, wherein the adjusting device is configured to adjust an intensity of a beep sound or a vibration.

8. The potty training system according to claim 1, wherein the potty training suit includes a front portion and a rear portion, the front portion defining a first opening to allow a head of the pet to come out, a second opening and a third opening to allow front legs of the pet to come out, the rear portion being connected to a rear end of the front portion and defining a Y configuration having a pair of extensions.

9. The potty training system according to claim 8, wherein free ends of the extensions are removably attached to the rear end of the front portion of the potty training suit.

10. The potty training suit according to claim 9, wherein the free ends of the extensions are removably attached to the rear end of the front portion to define a pair of openings to allow rear legs of the pet to come out.

11. The potty training system according to claim 1, wherein the collar alarm system is configured to be controlled manually or wirelessly.

12. A potty training system comprising:
a potty training suit configured to be worn by a pet and including:
a front portion defining a first opening, a second opening, and a third opening to allow a head and front legs of a pet to come out;
a rear portion connected to a rear end of the front portion and including a pair of extensions, wherein free ends of the extensions are removably attached to the rear end of the front portion to wrap around rear legs of the pet;
a wet sensor;
a wire connected to the wet sensor; and
a fastening member for attaching the wet sensor and the wire to an inner surface of the potty training suit; and
a collar alarm system including a control device and a mounting member for mounting the collar alarm system around a neck of the pet, the wire connecting the wet sensor to the control device of the collar alarm system,
wherein the wet sensor generates a signal when urine from the pet is detected, and transmits the signal to the control device of the collar alarm system via the wire, the control device of the collar alarm system providing an alert indicating the detection of the urine.
